(19) United States
(12) Patent Application Publication
(10) Pub. No.: US 2005/0011297 A1
(43) Pub. Date: Jan. 20, 2005

(54) Steering apparatus

(75) Inventors: Morito Oshita, Kariya-shi (JP); Yasuaki Kurokawa, Kariya-shi (JP); Masakazu Ozawa, Aichi-ken (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 10/855,558

(22) Filed: May 28, 2004

(30) Foreign Application Priority Data
May 30, 2003 (JP) 2003-154872

(51) Int. Cl. B62D 1/18

(52) U.S. Cl. 74/493

(57) ABSTRACT

A steering apparatus includes a steering column to which a steering wheel is connected, a first fixing portion for pivotably supporting the steering column relative to a vehicle body, a bracket secured to the steering column for supporting a drive unit, and a second fixing portion for supporting the steering column relative to the vehicle body and pivoting the steering column with respect to the first fixing portion by receiving an output of the drive unit. The second fixing portion is provided on the steering wheel side of the steering column relative to the bracket.

### CROSS REFERENCE TO RELATED APPLICATIONS

This application is based on and claims priority under 35 U.S.C. § 119 with respect to Japanese Application No. 2003-154872 filed on May 30, 2003, the entire contents of which are incorporated herein by reference.

### FIELD OF THE INVENTION

This invention generally relates to a steering apparatus for a vehicle.

### BACKGROUND OF THE INVENTION

A known steering apparatus for a vehicle includes a tilt mechanism for adjusting an inclination of a steering column by a drive force of a motor provided in the vicinity of a steering shaft.

U.S. Pat. No. 4,925,210 discloses such a steering apparatus for a vehicle including an electric motor 141 attached to an outer periphery of a steering column 200 as shown in FIGS. 5 and 6. The rotation force of the electric motor 141 is transmitted to a gear 140 engaging with a tip end portion of a rotating shaft of the motor 141 and a gear 144 via a chain 142. At this time, the gears 140 and 144 are rotated to thereby move spindles 131 and 132 in the vertical direction in FIG. 5, the spindles 131 and 132 serving as a shaft of each disk 137 having a screw bore and integrally supporting the steering column 200. That is, the steering column 200 is pivoted in the vertical direction of the vehicle since the respective positions of the screw bores of the spindles 131 and 132 move in the vertical direction.

According to the disclosed steering apparatus, the steering column 200 as a whole is supported by the spindles 131 and 132 in order to move the steering column 200 in the vertical direction in FIG. 5. Further, the rotation force from the electric motor 141 is transmitted between the spindles 131 and 132 via the chain 142 so that the respective disks 137 engaging with the spindles 131 and 132 are rotated at the same speed. Therefore, the structure for tilting the steering column is complicated. In addition, since the steering column is supported by two spindles, it may occur that the external force, which may be vertically applied to the two spindles, i.e. applied to an axial direction of the spindles, is not equally transmitted to the two spindles.

Thus a need exists for a steering apparatus having a simple structure and a high rigidity of a tilt mechanism.

### SUMMARY OF THE INVENTION

According to an aspect of the present invention, a steering apparatus includes a steering column to which a steering wheel is connected, a first fixing portion for pivotably supporting the steering column relative to a vehicle body, a bracket secured to the steering column for supporting a drive unit, and a second fixing portion for supporting the steering column relative to the vehicle body and pivoting the steering column with respect to the first fixing portion by receiving an output of the drive unit. The second fixing portion is provided on the steering wheel side of the steering column relative to the bracket.

### BRIEF DESCRIPTION OF THE DRAWING FIGURES

The foregoing and additional features and characteristics of the present invention will become more apparent from the following detailed description considered with reference to the accompanying drawing figures in which like reference numerals designate like elements.

FIG. 1 is a schematic side view of a steering apparatus according to a first embodiment of the present invention;

FIG. 2 is a partial cross-sectional view of the steering apparatus according to the first embodiment of the present invention;

FIG. 3 is a schematic side view of a steering apparatus according to a second embodiment of the present invention;

FIG. 4 is a partial cross-sectional view of the steering apparatus according to the second embodiment of the present invention;

FIG. 5 is a partial cross-sectional view of a steering apparatus according to a known art; and

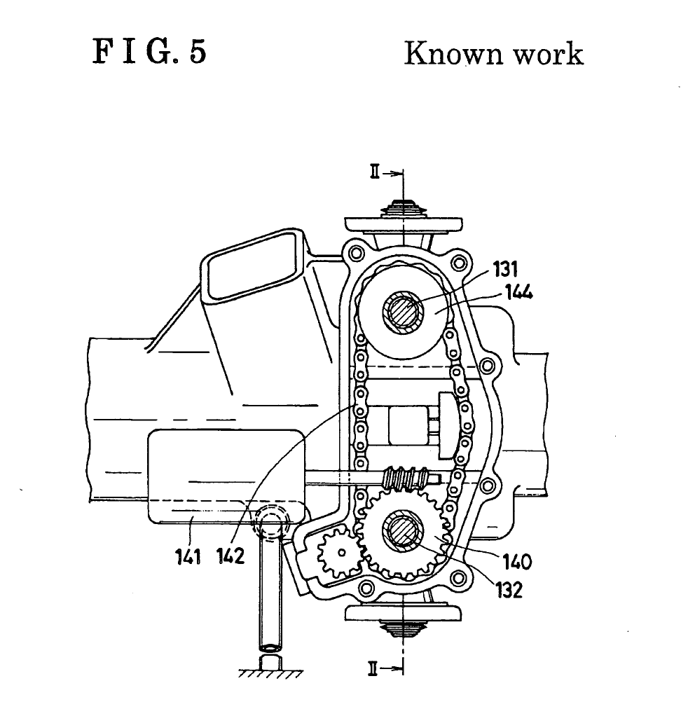

FIG. 6 is a rotated cross-sectional view taken along the line II-II of FIG. 5.

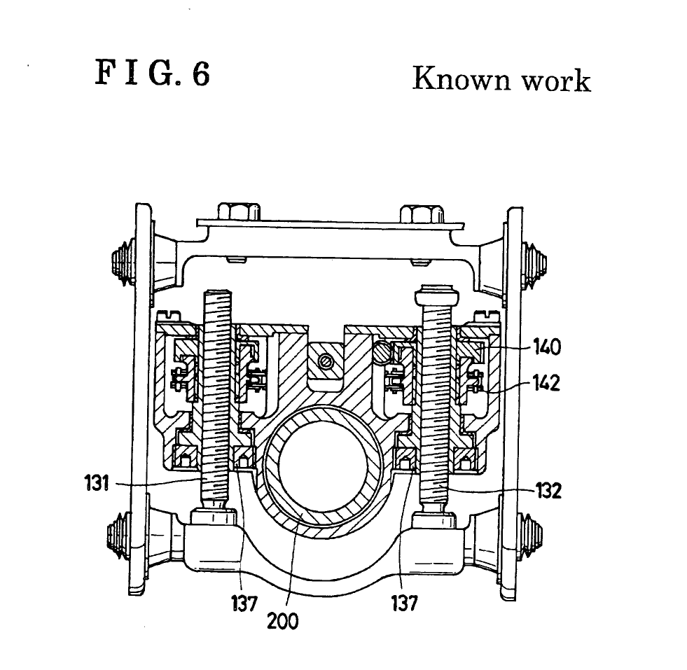

### DETAILED DESCRIPTION OF THE INVENTION

Embodiments of the present invention are explained referring to attached drawings.

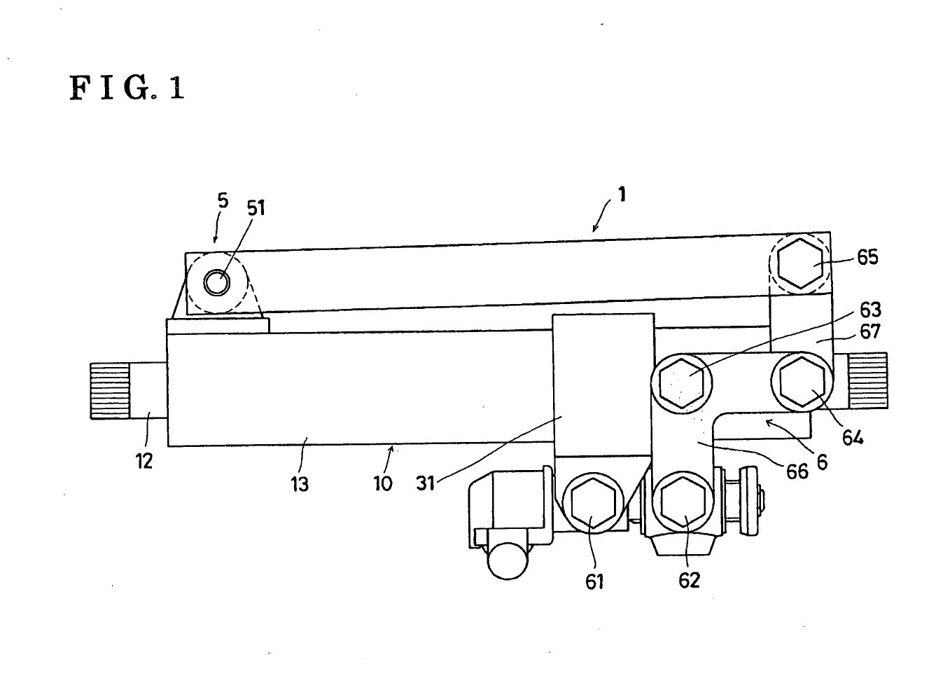

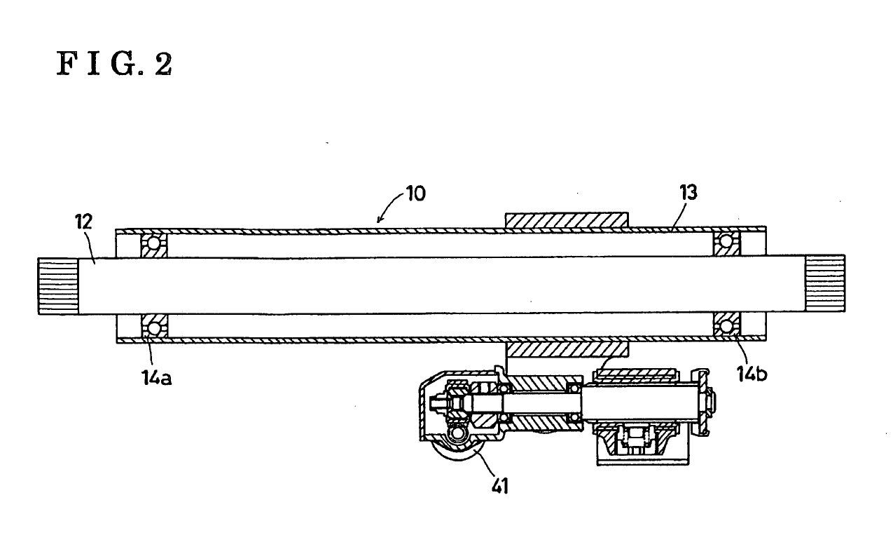

FIG. 1 is a schematic side view showing a basic structure of a steering apparatus 1 according to a first embodiment of the prevent invention. FIG. 2 is a partial cross-sectional view of the steering apparatus 1 of FIG. 1.

As shown in FIGS. 1 and 2, the steering apparatus 1 includes a steering column 10 having a linear shape and extending in substantially longitudinal direction of a vehicle, a first fixing portion 5 and a second fixing portion 6 via which the steering column 10 is secured to a vehicle body. The steering column 10 includes a steering shaft 12 whose one end is connected to a steering wheel (not shown in FIG. 1 or 2) while whose other end is connected to a steering gear box (not shown) via an intermediate shaft (not shown). The steering shaft 12 is disposed into a column tube 13, being rotatable about a first bearing 14a and a second bearing 14b.

The first fixing portion 5 is provided at a left end portion on an outer periphery of the column tube 13 in FIG. 1. That is, the first fixing portion 5 is provided in the vicinity of the steering shaft 12, being located close to an end portion thereof opposite the steering wheel. The second fixing portion 6 provided in an axially rightward direction of the steering column 10 in FIG. 1 is secured to the vehicle body via a pivot 65. In addition, the left end portion of the steering column 10 is secured to the vehicle body via a tilt center 51 of the first fixing portion 5 while the right end portion of the steering column 10 is secured to the vehicle body via a bracket 31, the second fixing portion 6 (bell crank 66 and I-shaped link 67) and the pivot 65.

The second fixing portion 6 includes a bell crank 66 consisting of a pair of L-shaped links and an I-shaped link 67 on one side of the steering column 10. The second fixing portion 6 also includes a pair of pivots 61 to 65 on opposite sides of the steering column 10 (10 pivots in total). The bell crank 66 and the I-shaped link 67 are each rotatably supported by the pivots 61 to 65 as shown in FIG. 1. A tilt motor 41 as a drive unit for rotating the second fixing portion 6 and an output shaft of the tilt motor 41 are secured to the column tube 13 via the bracket 31. The pivot 63 is arranged on the steering wheel side relative to the bracket 31 and also at the most rightward portion in FIG. 1 on the outer periphery of the column tube 13 (i.e. provided on a closest position to the steering wheel) as long as the structure is permitted in view of designing.

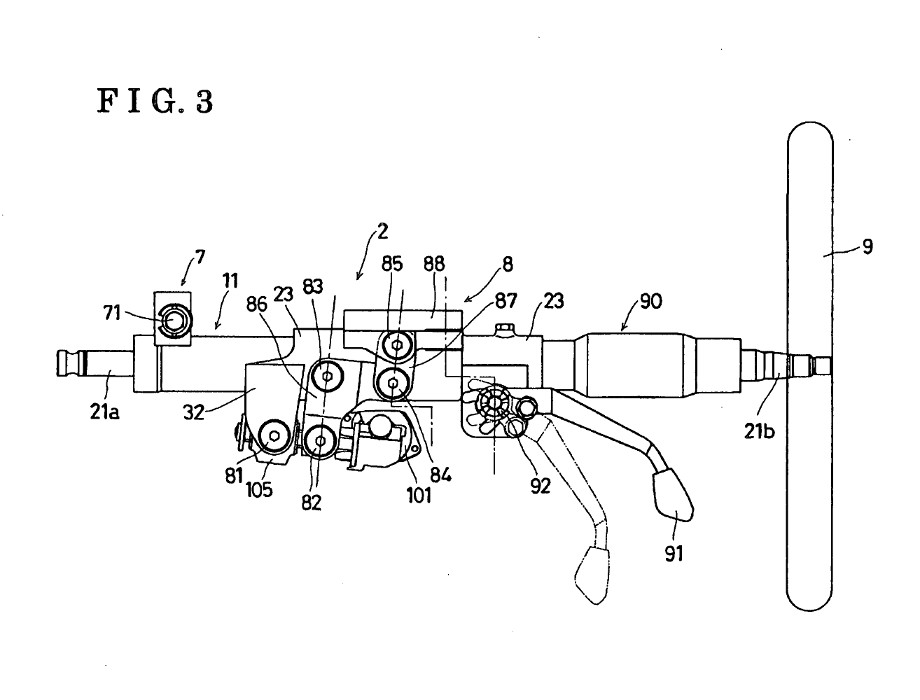

FIG. 3 is a view of a steering apparatus 2 having a telescopic feature according to a second embodiment of the present invention. In order to equip the steering column 10 with the telescopic feature, the steering shaft 12 is split into two pieces and the column tube 13 has a double-tube structure.

The second embodiment of the present invention is explained as follows by mainly focusing on the difference with the first embodiment.

As shown in FIG. 3, a second fixing portion 8 of a steering column 11 is attached to a tube housing 23 that is arranged on each outer periphery of a first tube 22a and a second tube 22b. An eccentric cam 92 for securing a second shaft 21b of a telescopic portion 90 at a predetermined position, and a telescopic lever 91 for rotating the eccentric cam 92 are provided on slightly right side from a center of the steering column 11 of the steering apparatus 2 in FIG. 3.

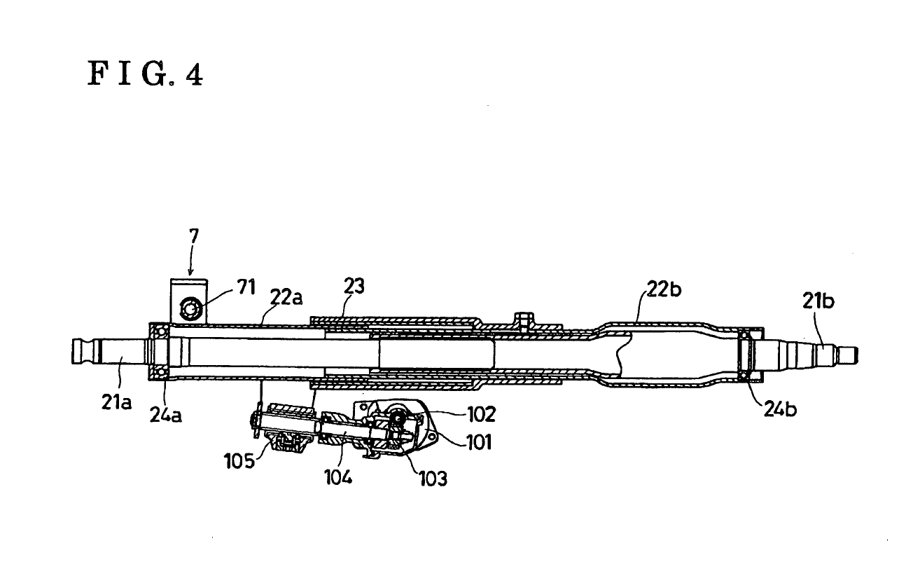

FIG. 4 is a partial cross-sectional view showing an internal portion of the steering column 11. The steering column 11 includes a first shaft 21a and the second shaft 21b each having a linear shape, the first tube 22a, the second tube 22b, and the tube housing 23. The first shaft 21a and the second shaft 21b are positioned in the first tube 22a and the second tube 22b respectively, being coaxially therewith. The first shaft 21a is supported by a first bearing 24a, being rotatable to the first tube 22a and not movable in the axial direction thereof. The second shaft 21b is supported by a second bearing 24b, being rotatable to the second tube 22b and not movable in the axial direction thereof.

Structures of a first fixing portion 7 and the second fixing portion 8 are substantially same as those of the first fixing portion 5 and the second fixing portion 6 of the first embodiment respectively. The first fixing portion 7 and the second fixing portion 8 are both secured to the vehicle body.

The structure of the second fixing portion 8 is explained as follows. A pair of bell cranks 86 and a pair of I-shaped links 87 are provided at the steering column 11. That is, each of the pair of bell cranks 86 and each of the pair of I-shaped links 87 are provided on each side (front side and back side in FIG. 3) of the steering column 11 and connected to each other via a pivot 84. A housing 88 of the second fixing portion 8 is connected to the I-shaped link via a pivot 85.

The housing 88 is secured to the vehicle body. The steering column 11 is secured to the vehicle body via a pivot 83. A slider 105 is rotatably supported at a lower portion of the bell crank 86 via a pivot 82 in FIG. 3. In addition, an arm 32 and a tilt worm 104 are rotatably supported via a pivot 81. The arm 32 is individually secured to the outer periphery of the tube housing 23.

The pivoting operation of the steering column 11 by a tilt motor 101 is explained as follows.

As shown in FIG. 4, a motor worm 102 serving as an output shaft of the tilt motor 101 is provided in substantially vertical direction to the axial direction of the first shaft 21a. The rotation force of the motor worm 102 is transmitted to a wheel 103 engaging with the motor worm 102. Then, the rotation force of a tilt worm 104 integrally rotating with the wheel 103 is transmitted to the slider 105. At this time, the slider 105 is secured to the arm 32 via the pivot 81 so as not to move relative to the arm 32. Therefore, the slider 105 does not move in the axial direction of the tilt worm 104. Then, the movement of the tilt worm 104 in the axial direction is converted into the rotation of the pivots 81 and 82 with respect to the pivot 83.

As shown in FIG. 3, the pivot 82 is connected to the bell crank 86. Thus, when the pivot 82 starts rotating, the bell crank 86 also rotates with respect to the pivot 83 since the bell crank 86 is secured to the steering column 11 via the pivot 83. Further, the bell crank 86 is connected to one end of the I-shaped link 87 via the pivot 84. The other end of the I-shaped link 87 is connected to the housing 88 via the pivot 85, i.e. connected to the vehicle body.

Since the housing 88 is secured to the vehicle body, the bell crank 86 receives a reaction force from the housing 88, which results in a force added to the pivot 83 in the bell crank 86. Then, the steering column 11 is pivoted, i.e. tilted with respect to a tilt center 71.

According to the above-mentioned embodiments, the steering column is supported by the first fixing portion, being pivotable with respect to the vehicle body. In addition, the steering column is pivoted by the second fixing portion. The second fixing portion includes a link mechanism for converting the rotation force of the output shaft of the motor into the pivoting movement of the steering column. Since the link mechanism is provided at the second fixing portion, the steering apparatus with a simple structure and a high rigidity may be obtained. Further, the second fixing portion for pivoting the steering column is provided close to the steering wheel on the steering column via the bracket. Therefore, the overhang amount at the steering shaft on the steering wheel side may be reduced, thereby also obtaining the high rigidity of the steering apparatus.

Further, according to the above-mentioned embodiments, the first fixing portion is provided at an end portion of the steering column opposite to the other end portion to which the steering wheel is connected. Therefore, the first fixing portion is arranged at the end portion of the steering column close to an intermediate shaft. That is, a fulcrum of the steering column for the pivoting movement in the vertical direction of the vehicle is provided close to feet of the driver, thereby effectively supporting the steering column relative to the vehicle body.

Further, according to the above-mentioned embodiments, the link mechanism includes a multiple crank portions. The pivoting operation of the steering column caused by the rotation of the motor as a driving force is achieved by the rotation of the link mechanism. Therefore, the pivoting operation of the steering column in the vertical direction may be realized by a small link mechanism by effectively utilizing a limited space above the steering column.

According to the aforementioned embodiments, the pivots 63 or 83 of the second fixing portion that receives the load directly by the vertical movement of the steering wheel is provided further from the tilt center of the first fixing portion, i.e. close to the steering wheel side. Thus, an arm ratio R1/R2 in which R1 is defined as a distance from the tilt center to the steering wheel and R2 is defined as a distance from the tilt center to the pivot 63 or 68 of the second fixing portion is small so that the load added to the pivot 63 or 68 is reduced, thereby achieving the high rigidity of the steering column. As a result, the structure of the steering apparatus may be simplified and small, and the rigidity of supporting the telescopic mechanism in the moving direction (i.e. vertical direction of the vehicle) may be assured.

The principles, preferred embodiment and mode of operation of the present invention have been described in the foregoing specification. However, the invention which is intended to be protected is not to be construed as limited to the particular embodiment disclosed. Further, the embodiment described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A steering apparatus comprising
a steering column to which a steering wheel is connected;
a first fixing portion for pivotably supporting the steering column relative to a vehicle body;
a bracket secured to the steering column for supporting a drive unit; and
a second fixing portion for supporting the steering column relative to the vehicle body and pivoting the steering column with respect to the first fixing portion by receiving an output of the drive unit; wherein the second fixing portion is provided on the steering wheel side of the steering column relative to the bracket.

2. A steering apparatus according to claim 1, wherein the second fixing portion includes a link mechanism having an L-shaped link for converting the output of the drive unit into a pivotal movement of the steering column.

3. A steering apparatus according to claim 1, wherein the first fixing portion is provided at one end portion of the steering column opposite to the other end portion at which the second fixing portion is provided.

4. A steering apparatus according to claim 2, wherein the first fixing portion is provided at one end portion of the steering column opposite to the other end portion at which the second fixing portion is provided.

5. A steering apparatus according to claim 2, wherein the link mechanism includes a plurality of rotation centers of the drive unit and the steering column.

6. A steering apparatus according to claim 1, wherein the first fixing portion includes a tilt center secured to the vehicle body.

7. A steering apparatus according to claim 5, wherein the link mechanism includes the L-shaped link, an I-shaped link, and a plurality of pivots.

8. A steering apparatus according to claim 7, wherein the L-shaped link and the I-shaped link are connected to each other via a first pivot of the plurality of pivots.

9. A steering apparatus according to claim 8, wherein the second fixing portion includes a housing secured to the vehicle body and connected to the I-shaped link via a second pivot of the plurality of pivots.

10. A steering apparatus according to claim 9, wherein the steering column is secured to the vehicle body via a third pivot of the plurality of pivots.
